(19) United States
(12) Patent Application Publication
(10) Pub. No.: US 2026/0318124 A1
(43) Pub. Date: Oct. 15, 2026

(54) VEHICLE DOOR LATCH

(71) Applicant: Kiekert Aktiengesellschaft, Heiligenhaus (DE)

(72) Inventors: Marco MERLETTI, Arsago Seprio (Varese) (IT); Mattia BIANCHI, Bidogno, Ticino (CH); Carlo MUTTI, Origlio (CH)

(73) Assignee: Kiekert Aktiengesellschaft, Heiligenhaus (DE)

(21) Appl. No.: 18/998,723

(22) PCT Filed: Jul. 21, 2023
(86) PCT No.: PCT/EP2023/070345

§ 371 Date: Jan. 27, 2025

(30) Foreign Application Priority Data
Aug. 1, 2022 (EP) 22 188 021.4

(51) Int. Cl. E05B 81/86; E05B 81/06; E05B 81/60

(52) U.S. Cl. CPC E05B 81/86; E05B 81/06; E05B 81/60

(57) ABSTRACT

Vehicle door latch (1) for a motor vehicle (2) and configured to receive a main supply voltage (Vbatt) from a main power source (8) of the motor vehicle (2) during a normal operating condition, comprising a supercapacitor group (3) configured to store energy during the normal operating condition and to provide a backup supply voltage (Vsc) during a failure operating condition different from the normal operating condition, an electric motor (4) configured for actuating the Vehicle door latch (1) based on the main supply voltage (Vbatt) during the normal operating condition and on the backup supply voltage (Vsc) during the failure operating condition, and a four-quadrant controller (5) comprising four switches, whereby each two switches form a series circuit with the electric motor (4) connected to an intermediate point between the two switches and the two series circuits are connected in parallel, whereby during the failure operating condition the four-quadrant controller (5) is operated with the backup supply voltage (Vsc).

### TECHNICAL FIELD

The invention relates to a vehicle door latch for a motor vehicle and configured to receive a main supply voltage from a main power source of the motor vehicle during a normal operating condition, a supercapacitor group configured to store energy during the normal operating condition and to provide a backup supply voltage during a failure operating condition different from the normal operating condition and an electric motor configured for actuating the vehicle door latch based on the main supply voltage during the normal operating condition and on the backup supply voltage during the failure operating condition.

### BACKGROUND ART

Several automotive systems require the presence in a vehicle of a backup energy source, to provide electrical energy in substitution, or as an aid to a main power supply of the vehicle, in case of failure or interruption of the same main power supply. Such backup power source is usually kept in a charged state during normal operation, by the main power supply of the vehicle, so as to be readily available as soon as the need arises, for example in case of an accident or crash of the vehicle.

US 2015/329009 A1 describes a backup energy source for an automotive system in a motor vehicle which is designed to receive a main supply voltage, during a normal operating condition, and to provide a backup supply voltage during a failure operating condition, different from the normal operating condition. The backup energy source has a control unit, and a supercapacitor group, operable by the control unit to store energy during the normal operating condition and to provide the backup supply voltage during the failure operating condition. A diagnostic module is coupled to the supercapacitor group to provide the control unit with information concerning an operating status of the supercapacitor group.

A power unit of the backup energy source includes a boost module, which provides at its output a boosted voltage as a function of a supercapacitor voltage feeding the automotive system during the failure operating condition. Providing such boost module makes the solution expensive and subject to failures in particular in the failure operating condition.

### SUMMARY OF INVENTION

It is therefore an object of the invention to provide an easy, cheap and reliable solution for feeding a vehicle door latch with a backup supply voltage during a failure operating condition.

The object of the invention is solved by the features of the independent claims. Preferred implementations are detailed in the dependent claims.

Thus, the object is solved by a vehicle door latch for a motor vehicle and configured to receive a main supply voltage from a main power source of the motor vehicle during a normal operating condition, comprising
a supercapacitor group configured to store energy during the normal operating condition and to provide a backup supply voltage during a failure operating condition different from the normal operating condition,
an electric motor configured for actuating the vehicle door latch based on the main supply voltage during the normal operating condition and on the backup supply voltage during the failure operating condition, and
a four-quadrant controller comprising four switches, whereby each two switches form a series circuit with the electric motor connected to an intermediate point between the two switches and the two series circuits are connected in parallel, whereby
during the failure operating condition the four-quadrant controller and/or the parallel connected series circuits of switches are operated with the backup supply voltage.

A key point of the invention is therefore that the four-quadrant controller is ‘booster-less’ connected to the supercapacitor group i.e. the backup supply voltage is not increased for operating the electric motor. Thus, the proposed vehicle door latch can be much simpler and cheaper implemented, not requiring any additional parts for boosting the backup supply voltage in the failure operating condition. The failure operating condition occurs

in case of failure of the main power supply of the vehicle, or in case of interruptions or breaking of an electrical connection between the main power supply and vehicle doors operated by the vehicle door latch, for example in case of an accident or crash involving the vehicle. In contrast thereto the normal operating condition should be understood as a mode in which the main power supply provides the electrical energy for operating the electric motor.

The main power source is preferably provided as a battery of the motor vehicle for example delivering 12 or 24 V DC. During the normal operating condition the main power source preferably charges the supercapacitor group. The motor vehicle and/or the vehicle door latch may in this respect comprise a charge module, in particular controllable by a control unit described below, for recharging the supercapacitor group, starting from the main supply voltage, whenever power from the main supply voltage is available. The electric motor is preferably configured for actuating the vehicle door latch in respect to locking and unlocking a door of the motor vehicle.

More generally, the expression “vehicle door latch” should be understood as a means for locking a movable element between an open position and a closed position, thereby opening and closing an access to an inner compartment of a motor vehicle, for example including, boot, rear hatches, bonnet lid or other closed compartments, window regulators, sunroofs, in addition to the side doors of a motor vehicle. The proposed vehicle door latch allows for complying with security and safety regulations requiring opening for example of the vehicle doors, even in case of failure of the main power supply of the vehicle, or in case of interruptions or breaking of the electrical connection between the main power supply and the vehicle doors. Such kind of situation may occur, for example, in case of an accident or crash involving the vehicle.

The vehicle can be provided as an electrical vehicle. The switch may be provided as MOSFET, in particular as p-channel MOSFET, or any other semiconductor switch known from prior art. The vehicle door latch may comprise a housing, made of metal, plastics or a combination thereof. The supercapacitor group, the electric motor and the four-quadrant controller are preferably provided within the housing. The term connected to an intermediate point between the two switches shall preferably be understood that each two switches form a branch, i.e. the series connection, while these two branches are bridged by a third branch connected to the intermediate points of the first two branches.

According to a preferred implementation the parallel connected series circuits are booster-less connected to the supercapacitor group. This means that the four-quadrant controller is operated with the backup supply voltage, which may differ from the main supply voltage. Compared to prior art implementation, no boost respectively increase of the backup supply voltage for example towards the main supply voltage is required, thus resulting in a much cheaper implementation as no boost converter or the like is required.

In another preferred implementation the vehicle door latch comprises a control unit configured for applying a pulse width modulated signal onto the four-quadrant controller. Pulse width modulating the four-quadrant controller means preferably that the four-quadrant controller is switched based on pulse width modulated signals. Pulse-width modulation, PWM, or pulse-duration modulation, PDM, is generally understood as a method of reducing an average power delivered by an electrical signal, by effectively chopping the signal up into discrete parts. Particularly, the electric motor can be operated based on such PWM signal by switching the backup supply voltage and/or the main supply voltage on and off. By varying the pulse width of the PWM signal, the speed of the electric motor can be controlled.

The control unit can be provided as a microprocessor, microcontroller or analogous computing module, configured to control operation of the four-quadrant controller, in particular also based on a value of the main voltage and/or of the backup supply voltage. Besides that the control unit may be configured for connecting to other controllers of the motor vehicle, such for example a control device of the motor vehicle.

The control unit can be further configured for determining if the value of the main voltage decreases below a predetermined threshold value so as to determine that an emergency condition respectively the failure operating condition is occurring, when the supercapacitor group as backup energy source is needed. In this respect the control unit may comprise an embedded memory, for example a non-volatile random access memory, coupled to a computing module, storing suitable programs and computer instructions, for example in the form of a firmware. The control unit may alternatively comprise a logical circuit of discrete components to carry out the functions of the computing module and memory.

In a further preferred implementation the control unit is configured to receive a current signal from the four-quadrant controller. Based on said current signal the control unit may determine a switching and/or operating status of the switches and/or of the four-quadrant controller. The control unit may, based on said current signal, detect at least a value of the backup supply voltage, and to monitor, during recharging the supercapacitor group, an equivalent series resistance, ESR, and/or a value of capacitance of the supercapacitor group, based on said recharging process.

In another preferred implementation the supercapacitor group comprises at least a first supercapacitor cell, preferably at least a first and a second supercapacitor cells, connected to each other, to jointly provide the backup supply voltage. A supercapacitor cell, also referred to as supercapacitor, supercap, SC, or called an ultracapacitor, is typically a high-capacity capacitor with a capacitance value much higher than other capacitors, but with lower voltage limits, that bridges the gap between electrolytic capacitors and rechargeable batteries. The supercapacitor typically stores 10 to 100 times more energy per unit volume or mass than electrolytic capacitors, can accept and deliver charge much faster than batteries, and tolerates many more charge and discharge cycles than rechargeable batteries.

The supercapacitor cell comprises, when fully charged, for example the voltage of 2.45 V. Thus, if the first and the second supercapacitor cells are connected to each other, the jointly provided backup supply voltage equals 4.9 V. Preferably, at least two, two, three or four supercapacitor cells are connected in series forming the supercapacitor group. The vehicle battery preferably comprises a voltage of 12 V. The motor vehicle and/or the vehicle door latch may comprise a charge module, controllable by the control unit, to recharge the supercapacitor group, starting from the main supply voltage, whenever power from the main supply voltage is available.

In a further preferred implementation, the four-quadrant controller is provided as H-bridge and/or the switches are provided as MOSFETs. Generally, a H-bridge is an electronic circuit that switches the polarity of a voltage applied to a load, here the main supply voltage and/or the backup supply voltage as voltage and the electric motor as load. By means of such H-bridge the electric motor can be run forwards or backwards, for example for locking or unlocking a door of the motor vehicle. The name is derived from its common schematic diagram representation, with four switches configured as branches of a letter “H” and a load i.e. the electric motor connected as the cross-bar. A solid-state H-bridge is typically constructed using opposite polarity switches, such as PNP bipolar junction transistors or p-channel MOSFETs connected to the main power source and n-channel MOSFETs connected to ground. Alternatively, p-channel or n-channel MOSFETs can be used on both sides.

In another preferred implementation the parallel connected series circuits are directly connected to the supercapacitor group or comprising a connection switch directly connected the parallel connected series circuits and the supercapacitor group. Said connection switch is preferably provided as MOSFET, in particular as p-channel MOSFET. The connection switch can be operated for example by the connection switch for connecting the supercapacitor group during the failure operating condition to the four-quadrant controller for operating the electric motor.

The object is further solved by a motor vehicle comprising a vehicle door latch as described before and the main power source, whereby the main power source is connected to the parallel connected series circuits of switches and/or to the four-quadrant controller.

Thus, during the normal operating condition, the main power source operates for the four-quadrant controller for actuating the electric motor for, for example, locking and unlocking a door of the motor vehicle.

In another preferred implementation the motor vehicle comprises a rectifier diode diode connected between the main power source and the parallel connected series circuits of switches. An anode of the rectifier diode diode is preferably connected to the main power source and a cathode of the rectifier diode diode is preferably connected to the four-quadrant controller respectively to an other end of the parallel connected series circuits of switches not connected to ground. The rectifier diode diode is preferably provided as Schottky diode.

The object is further solved by a method for operating a vehicle door latch of a motor vehicle, whereby the vehicle door latch comprises
a supercapacitor group configured to store energy received from a main power source of the motor vehicle during a normal operating condition and to provide a backup supply voltage during a failure operating condition different from the normal operating condition, and
a four-quadrant controller comprising four switches, whereby each two switches form a series circuit with an electric motor configured for actuating the vehicle door latch connected to an intermediate point between the two switches and the two series circuits are connected in parallel, comprising the step of:
Operating the four-quadrant controller during the normal operating condition with the main supply voltage, and
Operating the four-quadrant controller during the failure operating condition with the backup supply voltage.

With such method the electric motor of the vehicle door latch can be operated during the normal operating condition with the main supply voltage and during the failure operating condition with the backup supply voltage with requiring a boost converter of the like for increase the backup supply voltage towards a level of the main supply voltage.

Further implementations and advantages of the vehicle door latch can be derived by the person skilled in the art from the vehicle door latch as described above.

### BRIEF DESCRIPTION OF DRAWINGS

These and other aspects of the invention will be apparent from and elucidated with reference to the implementation described hereinafter.

In the drawings:

FIG. 1 shows a schematic circuit diagram comprising a supercapacitor group, an electric motor for actuating the vehicle door latch and a four-quadrant controller of a vehicle door latch according to a preferred implementation.

### DESCRIPTION OF IMPLEMENTATIONS

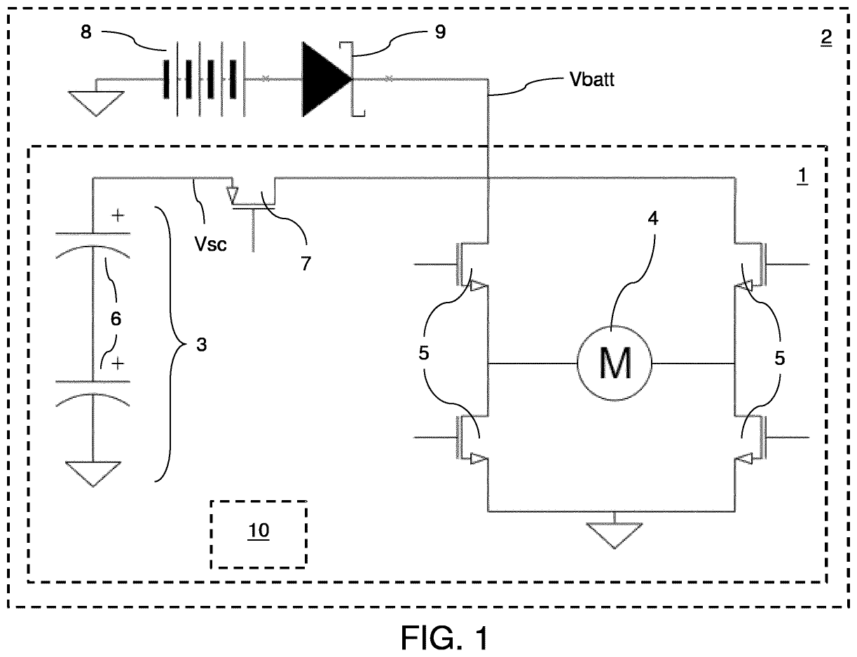

FIG. 1 shows a schematic circuit diagram an only schematically depicted vehicle door latch 1 of an only schematically depicted motor vehicle 2. The motor vehicle 2 includes for side doors, not shown, which are each equipped with one vehicle door latch 1. Besides that the vehicle door latch 1 can be associated to rear hatches, bonnet lid or other closed compartments, window regulators, sunroofs, in addition to the side doors of such motor vehicle 2.

The vehicle door latch 1 comprises a housing made of plastic, metal or a combination thereof. The housing houses arranged therein a supercapacitor group 3, electric motor 4 and a four-quadrant controller 5. The motor vehicle 2 comprises a main power source 8 provided as standard vehicle battery known from prior art and delivering a main supply voltage Vbatt of 12 V DC during a normal operating condition.

The supercapacitor group 3 comprises a first and a second supercapacitor cells 6 connected in series, with the first supercapacitor cell 6 connected with its negative pole to ground. Each supercapacitor cell delivers, when fully charged, a voltage of 2.45 V DC i.e. the supercapacitor group 3 delivers a backup supply voltage Vsc of 4.9 V DC. Besides that more than two supercapacitors cells 6 can be connected in series and such wise delivering a higher backup supply voltage Vsc.

The four-quadrant controller 5 is provided as H-bridge and thus comprises four switches, which are provided as n-channel MOSFETs. Each two switches form a series circuit with one end connected to ground. The electric motor 4 is connected with its first pole to a first intermediate point between the first two serious connected switches and with its second pole a second intermediate point between the second two serious connected switches. The two series circuits of switches are connected in parallel, with said one end connected to ground.

The other end of the parallel connected series circuits of switches is connected via a connection switch 7 provided as p-channel MOSFET to the positive pole of the second supercapacitor cell 6. Thus, the backup supply voltage Vsc is not increased by any boost converter or the like i.e. the parallel connected series circuits are booster-less connected to the supercapacitor group 3. The other end is further connected via a rectifier diode diode 9, which is provided as Schottky diode, to the main power source 8.

During said normal operating condition the supercapacitor group 3 is charged by the main power source 8 and the electric motor 4 is operated based on the main supply voltage Vbatt delivered by the main power source 8. During a failure operating condition different from the normal operating condition, for example during a crash when the main power source 8 is disconnected from the four-quadrant controller 5, the supercapacitor group 3 delivers the backup supply voltage Vsc on which the parallel connected series circuits of switches are operated with for providing electrical energy to the electric motor 4.

The vehicle door latch 1 further comprises a control unit 10 provided as microprocessor, which is configured for applying a pulse width modulated signal onto the four-quadrant controller 5 for thereby operating the electric motor 4 in forward and backward direction. The control unit 10 is further configured to receive a current signal from the four-quadrant controller 5 for thereby determining a status of the four-quadrant controller 5 respectively of the electric motor 4.

While the invention has been illustrated and described in detail in the drawings and foregoing description, such illustration and description are to be considered illustrative or exemplary and not restrictive; the invention is not limited to the disclosed implementations. Other variations to be disclosed implementations can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting scope.

### Bezugszeichenliste

1 vehicle door latch
2 motor vehicle
3 supercapacitor group
4 electric motor
5 four-quadrant controller
6 supercapacitor cell
7 connection switch
8 main power source
9 rectifier diode diode
10 control unit
Vbatt main supply voltage
Vsc backup supply voltage

1. A vehicle door latch for a motor vehicle, the vehicle door latch being configured to receive a main supply voltage from a main power source of the motor vehicle during a normal operating condition, the vehicle door latch comprising:
a supercapacitor group configured to store energy during the normal operating condition and to provide a backup supply voltage during a failure operating condition different from the normal operating condition,
an electric motor configured for actuating the vehicle door latch based on the main supply voltage during the normal operating condition and on the backup supply voltage during the failure operating condition,
a four-quadrant controller comprising four switches, wherein a first two switches of the four switches form a first series circuit and a second two switches of the four switches form a second series circuit with the electric motor connected to an intermediate point between the first and second two switches, and the first and second series circuits are connected in parallel, and
wherein during the failure operating condition, the parallel connected first and second series circuits are operated by the backup supply voltage,
wherein the parallel connected first and second series circuits are booster-less connected to the supercapacitor group,
wherein the parallel connected first and second series circuits are directly connected to the supercapacitor group or include a connection switch directly connecting the parallel connected first and second series circuits and the supercapacitor group, and
the vehicle door latch further comprising a control unit configured for applying a pulse width modulation signal onto the four-quadrant controller.

2. The vehicle door latch according to claim 1, wherein the control unit is configured to receive a current signal from the four-quadrant controller.

3. The vehicle door latch according to claim 1, wherein the supercapacitor group comprises at least a first supercapacitor cell.

4. The vehicle door latch according to claim 1, wherein the four-quadrant controller is provided as an H-bridge and/or the switches are provided as MOSFETs.

5. A motor vehicle comprising the vehicle door latch according to claim 1 and the main power source, wherein the main power source is connected to the parallel connected first and second series circuits.

6. The motor vehicle according to claim 5 further comprising a rectifier diode diode connected between the main power source and the parallel connected first and second series circuits.

7. A method for operating a vehicle door latch of a motor vehicle, the vehicle door latch being configured to receive a main supply voltage from a main power source of the motor vehicle during a normal operating condition, wherein the vehicle door latch comprises:
a supercapacitor group configured to store energy received from the main power source of the motor vehicle during a normal operating condition and to provide a backup supply voltage during a failure operating condition different from the normal operating condition, and
a four-quadrant controller comprising four switches, wherein a first two switches of the four switches form a first series circuit and a second two switches of the four switches form a second series circuit with the electric motor connected to an intermediate point between the first and second two switches, and the first and second series circuits are connected in parallel, the method for operating comprising the steps of:
operating the four-quadrant controller during the normal operating condition with the main supply voltage, and operating the four-quadrant controller during the failure operating condition with the backup supply voltage.

8. The vehicle door latch according to claim 1, wherein the parallel connected first and second series circuits are directly connected to the supercapacitor group.

9. The vehicle door latch according to claim 1, further comprising a connection switch, wherein the connection switch is disposed between the parallel connected first and second series circuits and the supercapacitor group.

10. The vehicle door latch according to claim 3, wherein the supercapacitor group includes a first supercapacitor cell and a second supercapacitor cell connected to each other to jointly provide the backup supply voltage.

11. The vehicle door latch according to claim 4, wherein the electric motor is configured to run forward and backwards to lock and unlock the vehicle door latch.

12. The vehicle door latch according to claim 6, wherein the rectifier diode diode is Schottky diode.
